(19) United States
(12) Patent Application Publication
(10) Pub. No.: US 2011/0296627 A1
(43) Pub. Date: Dec. 8, 2011

(54) METHOD OF TREATING FABRIC IN A CLOTHES DRYER WITH A WATER-ACTIVATED DRYER SHEET

(76) Inventor: J. Michael Ogden, Cincinnati, OH (US)

(21) Appl. No.: 13/194,077

(22) Filed: Jul. 29, 2011

Related U.S. Application Data
(63) Continuation-in-part of application No. 11/422,889, filed on Jun. 8, 2006, now Pat. No. 7,989,413.
Application No. 11/422,889 is a continuation-in-part of application No. 10/826,975, filed on Apr. 16, 2004, now abandoned.
Application No. 10/826,975 is a continuation-in-part of application No. 10/119,343, filed on Apr. 8, 2002, now abandoned.

(51) Int. Cl. D06B 1/10; B05D 3/02

(52) U.S. Cl. 8/137; 427/384

(57) ABSTRACT

A method of treating fabric in a rotary clothes dryer is provided in which a substantially non-ionic liquid fabric treating composition is applied to a non-woven substrate, dried on the substrate to form a water-activated dryer sheet and then transferred during the course of a drying cycle from the water-activated dryer sheet to damp clothing within a clothes dryer as a result of contact of the composition with water contained within the damp clothing.

### CROSS-REFERENCE TO RELATED APPLICATIONS

This application is a continuation-in-part of co-pending U.S. application Ser. No. 11/422,889 filed on Jun. 8, 2006 which is a continuation-in-part of U.S. patent application Ser. No. 10/826,975 filed on Apr. 16, 2004, now abandoned and, which is a continuation-in-part of U.S. patent application Ser. No. 10/119,343 filed on Apr. 8, 2002, now abandoned. The foregoing applications are expressly incorporated herein by reference in their entirety to form a part of the present disclosure.

### FIELD OF THE INVENTION

This invention relates to a method of treating fabric in a rotary clothes dryer, and, more particularly, to a fabric treating method in which a substantially non-ionic liquid fabric treating composition is applied to a non-woven substrate, dried on the substrate to form a water-activated dryer sheet and then transferred during the course of a drying cycle to damp clothing within a clothes dryer as a result of contact of the composition with water contained within the damp clothing.

### BACKGROUND OF THE INVENTION

Fabric treating compositions have been developed which are capable of imparting one or more of a variety of properties to articles of clothing, such as softness, fragrance, brightening, bodying, reduced static, anti-soiling, anti-creasing and others. Two of the most prominent commercially available methods of treating clothing include liquid fabric softeners employed in washing machines, and “dry” dryer sheets used in clothes dryers.

One liquid fabric softener is commercially available from The Proctor & Gamble Company of Cincinnati, Ohio under the trademark Downy®. Liquid fabric softeners of this general type are comprised of cationic compounds, and particularly quaternary ammonium and imidazolinium salts, in the form of liquid emulsions. They are introduced into the washing machine and added to the clothing during the rinse cycle.

Although effective in imparting softness and reducing static cling, liquid fabric softeners have a number of deficiencies. One limitation is that they are inconvenient to use. Often sold in relatively large and heavy containers, liquid fabric softeners must be poured into the relatively small cap of the container, a cup or other measuring device to obtain the proper quantity for a particular size load of wash. The liquid softener is then poured into a receptacle in the washing machine where it is held until the rinse cycle begins. It is easy to spill the liquid softener, both when measuring and pouring it into the washing machine, and then one needs to clean the cap or other measuring device after use.

Another problem with liquid fabric softeners is that the entire content of the washing machine is subjected to the softening agent when it is applied in this fashion. It may be desirable to soften only some of the clothes being washed in a particular washing cycle, but in order to do that the clothing must be separated beforehand and additional loads of wash run. This is not only inefficient but uses additional energy and water.

A still further deficiency of liquid fabric softeners is their effect on the flammability of clothing items. According to tests conducted by Consumer Reports, liquid fabric softener added to the rinse water in washing machines accelerates the burn rate of most fabrics tested. For example, in one test, a terry-cloth bathrobe laundered with liquid fabric softener took just 1.9 seconds to burn a five inch path whereas the same fabric without the fabric softener took 13 seconds to burn the same five inch path. Although the rate of burn varies with the type of fabric, seconds count when clothing catches fire.

With respect to “dryer sheets,” one product of this type is commercially available from The Proctor & Gamble Company of Cincinnati, Ohio under the trademark Bounce®. Dryer sheets of this type generally comprise sheets of non-woven material impregnated with a composition usually consisting of a cationic softening agent, antistatic agents, dispersing agents and a fragrance. The softening or other fabric treating agent is applied to the non-woven material and then dried in an oven so that it is completely “dry” when ready for use. A dryer sheet(s) is placed into a rotary clothes dryer with freshly laundered, damp items of clothing, where it remains for the entire drying cycle. Once the clothes are dry, the composition on the sheet of non-woven material is released as a result of the heat within the clothes dryer and contact with the clothing induced by the tumbling action of the dryer.

Although much more convenient to use than liquid fabric softeners, the dryer sheets described above also have a number of limitations. First, dryer sheets exhibit relatively poor softening capability compared to liquid fabric softeners. One reason for this is that dryer sheets depend to a large extent on physical contact with the clothing within the dryer during the drying cycle in order to transfer the softening composition to the clothes. If the dryer sheet becomes trapped within the sleeve of a shirt, a pant leg or the like, it cannot make contact with other articles of clothing within the dryer. Even if the dryer sheet does not become trapped within an article of clothing during a drying cycle, the softening agent it carries is transferred only to those areas of the clothing with which the dryer sheet makes direct contact. The result is essentially a spotting effect on the clothing, e.g. some areas or points on the clothing receive the softening composition and other areas do not.

Another limitation of dryer sheets of the type described above is that a relatively high temperature is required in order to activate the softening or other fabric treating agent on the non-woven sheet and release it into or onto the fabric of the clothing. Most clothes dryers have several heat settings to accommodate different types of clothing. For example, delicate fabrics are preferably dried at lower heat settings and temperatures than clothing made from cotton or the like. At lower heat settings, dryer sheets are of marginal, if any, effectiveness and therefore delicate fabrics or other clothing dried at lower temperatures may not exhibit the desired softness and feel when worn. This is a pervasive problem in many European countries, as well as other countries around the world, where the high cost of energy makes it a necessity to operate clothes dryers at lower temperatures. On the other hand, it has been observed that clothing dried at high heat settings and temperatures often exhibit an increased amount of static cling and wrinkling. This is true even when the dryer sheet is provided with anti-static agents. Furthermore, in addition to creating static cling and wrinkling, high drying temperatures are harder on fabrics, tending to break them down over time.

### SUMMARY OF THE INVENTION

A method of treating fabric in a rotary clothes dryer is provided in which a substantially non-ionic liquid fabric treating composition is applied to a non-woven substrate, dried on the substrate to form a water-activated dryer sheet and then transferred during the course of a drying cycle to damp clothing within a clothes dryer as a result of contact of the composition with water contained within the damp clothing.

This invention is predicated on the concept of using the presence of water within the damp clothing placed in a rotary clothes dryer after washing to achieve the transfer of at least one active ingredient contained in a fabric treating composition from a substrate carrying the composition to the clothing. The components of the fabric treating composition may be combined at ambient temperature, without the addition of heat, and may be applied onto the substrate, preferably a sheet of non-woven material, and released from the substrate, without the addition of heat.

A wide variety of active ingredients may be employed in the fabric treating composition of this invention, depending upon the particular property or properties to be imparted to the clothing. Such active ingredients may include, without limitation, anti-creasing agents, anti-soil agents, brightening agents, bodying agents, softening agents, dyes, fiber emollients, finishing agents, fragrances, insect repellants, germicides, lubricants, mildew-proofing agents, moth-proofing agents, shrinkage controllers and sizing agents. Additives and auxiliaries may also be included in the composition, such as preservatives, anti-static agents, fragrances and others.

A number of important advantages are obtained with the water-activated dryer sheet of this invention compared to the prior art. Unlike liquid softening compositions introduced into the washing machine, the water-activated dryer sheet herein is extremely easy and convenient to use—no measuring, no spilling, no heavy container to pour from, no clean up of a measuring cap or cup and no need to separate clothing before washing according to what items are to be softened or not. Further, the fabric treating composition employed in the present invention does not increase the flammability of fabric, which is of particular concern with many liquid fabric softeners currently offered on the market.

Other advantages of the present invention highlight the deficiencies of the dryer sheets described above. The active ingredient(s) in the fabric treating composition employed in the present invention is transferred into or onto the fabric of clothing within a clothes dryer operated at ambient temperature, or at any heat setting. Unlike prior art dryer sheets which are activated only at high temperatures, the active ingredient(s) in the fabric treating composition of the present invention is transferred to articles of clothing within the dryer as a result of contact of the composition with the water contained in the damp clothing. As discussed in more detail below, such transfer occurs before the articles of clothing are heated and lose their water content.

### DETAILED DESCRIPTION OF THE INVENTION

For purposes of the present discussion, the term “water-activated dryer sheet” refers to a substrate impregnated with a liquid fabric treating composition that is then dried on the substrate, wherein transfer of the composition to damp articles of clothing within a clothes dryer during a drying cycle is permitted as a result of contact of the fabric treating composition with water contained in the clothing. The term “active ingredient” refers to a wide variety of components which, when applied to an article of clothing, are capable of imparting a particular property or characteristic to an article of clothing. The term “active ingredient” also is intended to encompass components which may be applied to a substrate within the clothes dryer during the course of a drying cycle, and then imparted to the skin of a wearer of the clothing. The term “article of clothing” is intended to be broadly construed as applying to essentially any item which is commonly dried in a clothes dryer, including, without limitation, clothing, sheets, towels, rugs and other items made of fabric. Additionally, the term “clothes dryer” or “rotary clothes dryer” refers to a rotary hot air dryer which includes a rotating drum within which articles to be dried are subjected to a flow of heated air, typically at a temperature of about 40° C. to 90° C.

### Fabric Treating Composition

The fabric treating composition of this invention generally comprises a carrier, an emulsifier and one or more active ingredients each capable of imparting a particular property or characteristic to an article of clothing within a clothes dryer during the course of a drying cycle. Such active ingredients may include, without limitation, anti-creasing agents, anti-soil agents, anti-static agents, bacteriostatic agents, brightening agents, bodying agents, softening agents, dyes, fiber emollients, finishing agents, fragrances, insect repellants, germicides, lubricants, mildew-proofing agents, moth-proofing agents, shrinkage controllers and sizing agents.

In the presently preferred embodiment, the carrier is water. The active ingredients noted above may include different classes of compounds, as is well known to those of ordinary skill in the art. Further, the fabric treating composition of this invention may be added to the carrier to form a solution, dispersion or emulsion at ambient temperatures, without the addition of heat.

One particular type of active ingredient suitable for use in the fabric treating composition of this invention may comprise a single material or a mixture of materials which are known to provide benefits to the skin. As discussed below, the fabric treating composition is applied in liquid form on a substrate, dried to form a water-activated dryer sheet and then transferred from the water-activated dryer sheet to articles of clothing within a clothes dryer during the course of a drying cycle. Clothing which receives a skin-treating active ingredient from the water-activated dryer sheet of this invention during a drying cycle within a clothes dryer subsequently transfers it to the skin when the clothing is worn by an individual.

The skin-treating active ingredient can comprise essentially any known component for treating human skin, such as insect repellants, UV absorbers, skin moisturizers, tanning agents, wrinkle removers, deodorants, cellulite reducers, vitamins, anti-oxidants, minerals, lipid layer enhancers, hair growth suppressants, emollients, botanical actives and the like. The skin treating active ingredient can be derived from a broad range of classes of materials such as emollients, lubricants, super-fatting agents, natural extracts which provide benefits to the skin depending upon the nature of the natural extracts, the lees from wine-making, DNA derivatives, hydrolyzed proteins both of animal and vegetable origin, derivatives of the hydrolyzed proteins, plant extracts, the skin-active portions of plant extracts and the like.

One particular skin-treating active ingredient suitable for use in the fabric treating composition of this invention is commercially available under the trademark “Plantatex” owned by Cognis IP Management GmbH. “Plantatex” is a wax dispersion with glyceryl esters, an emulsifier and water that transfers wax crystals to fabrics during the course of a drying cycle in a clothes dryer, as discussed below. It contains skin treating components such as glycerol oleate, which is a lipid layer enhancer. Other active ingredients which incorporate wax crystals may also be used in the fabric treating composition employed in the method of this invention. Generally, the temperature at which the wax crystals in such compositions melt is in the range of about 40-60° C., although that is variable to some extent dependent upon the size and type of the wax crystals.

An emulsifier may be added to the fabric treating composition herein, especially when using active ingredients containing wax crystals such as “Plantatex.” The emulsifier functions to assist in maintaining the wax crystals in suspension within the fabric treating composition so that they may be more evenly distributed when applied to a substrate. Non-anionic emulsifiers, which are well known in the art, are preferably used in the fabric treating composition of the water-activated drying sheet.

The fabric treating composition may further include one or more additives and auxiliaries to provide known benefits to the treated articles of clothing such as anti-static properties, a pleasing aroma, improved shelf life and the like. For example, preservatives such as formaldehyde, parabens, pentanediol, sorbic acid and other classes of compounds may be added, as is well known in the art. A number of different fragrances can be employed in the composition to create the desired smell of the clothing, including, without limitation, rose oil, lavender, lilac, jasmine, vanilla, wisteria, lemon, apple blossom or compound bouquets such as citrus, spice, aldehydic, woods, oriental, baby powder and others.

As noted above, the fabric treating composition is applied to a substrate, dried on the substrate to form a water-activated dryer sheet, and then the water-activated dryer sheet is placed into a clothes dryer with damp clothing while the clothing is dried. One or more active ingredients in the fabric treating composition are transferred from the substrate to the clothing during the course of a drying cycle as a result of contact with water contained in the clothing. In order to enhance such transfer of the active ingredient(s), the fabric treating composition is preferably substantially non-ionic. In contrast to cationic components that are typically employed in prior art dryer sheets and liquid fabric softeners of the type discussed above, non-ionic components do not have high absorbency on fabrics. This property allows the active ingredient(s) of the fabric treating composition to more readily transfer from the substrate onto the clothing within a clothes dryer during the course of a drying cycle. The term “substantially non-ionic” as used herein refers to a fabric treating composition whose components are predominantly non-ionic, with the exception of minor amounts of cationic components, such as, for example, cationic anti-static agents that may be incorporated into the composition.

### Substrate

In the presently preferred embodiment, the substrate is formed of a sheet of non-woven material which is particularly suited to the present application due to its relatively low cost, ease of processing, biodegradation capability and ability to absorb moisture. Non-woven material may be formed of natural fibers such as cellulosic, plant-based, polylactic acid material etc., or synthetic fibers such as polyester, nylon, polypropylene, polytrimethylene terephthalate and polyethylene terephthalate, or, blends of such natural and synthetic fibers. The fibers are formed in a sheet, typically by hydro-entanglement or needle-entanglement.

As noted above, in the method of treating fabric of this invention one or more active ingredients are transferred from the substrate to clothing during the course of a drying cycle within a clothes dryer. In addition to providing a substantially non-ionic fabric treating composition for this purpose, transfer of the active ingredient(s) is enhanced by employing a non-woven material made of synthetic fibers such as polyester, nylon, polypropylene, polytrimethylene terephthalate and polyethylene terephthalate. Synthetic fibers exhibit little or no absorbency, but are rather adsorbent which facilitates the release of the active ingredient(s) from the non-woven sheet and its transfer to the clothing. One presently preferred non-woven material is commercially available from Jacob Holm Industries (America) Inc. under the trademark “Lidro,” having a basis weight of 50 grams per square meter and formed of 100% polyethylene terephthalate.

### Method of Treating Fabric in a Clothes Dryer

In the presently preferred embodiment, the water-activated dryer sheet is manufactured by a process comprising the steps of applying a fabric treating composition to the substrate, in liquid form, and then drying the composition on the substrate to form the water-activated dryer sheet. The fabric treating composition may be applied to the substrate by spraying, dipping or other suitable method. As noted above, an emulsifier is preferably employed in fabric treating compositions containing wax crystals so that when the composition is applied to the substrate the wax crystals are substantially evenly distributed along the substrate instead of “clumping” or concentrating in discrete areas.

The substrate is then transferred to a drying station, preferably including an accumulator or similar device, where the liquid fabric treating composition residing on the substrate is dried to form a water-activated dryer sheet. One suitable accumulator is commercially available from L.R. Schmitt Nachfolger Sondermaschinenbauges m.b.H, of Aschaffenburg, Germany under Model No. SWSP 45. Other devices may be employed at the drying station, such as those including a series of rollers located within a housing over which the substrate passes and is exposed to ambient temperatures, or heat (heated air, heat lamps etc), for drying. In the event the fabric treatment composition includes one or more active ingredients containing wax crystals, any heat applied to the substrate and fabric treating composition at the drying station is less than the melt temperature of the wax crystals. If the wax crystals melt onto the fibers of the non-woven material forming the substrate, transfer of the active ingredient to the clothing would be prevented or at least seriously impaired. Following drying, the substrate may be cut into individual sheets, typically having a width and length each in the range of about 15-20 cm, and then packaged.

The method of treating fabric within a clothes dryer employing the water-activated dryer sheet of this invention proceeds as follows. At least one water-activated dryer sheet is placed in the interior of a clothes dryer atop freshly laundered “damp” clothing, as defined below, following the laundering operation in a conventional clothes washing machine. No bag or other container is employed to enclose the water-activated dryer sheet with the damp clothing to be dried, unlike the arrangement employed in the fabric treatment kit disclosed in U.S. Pat. No. 5,658,651, for example. Without wishing to be limited by any particular theory of operation, it is believed that the water-activated dryer sheet functions as follows. The active ingredient(s) within the fabric treating composition is transferred to the clothes within the interior of a clothes dryer as a result of contact of the composition with the rinse water held within the damp clothing following laundering of the clothing. No precise volumetric measurement can be given for the amount of water contained within freshly laundered articles of clothing due to variations in the efficiency of the spin cycle of different washing machines that follows one or more rinse cycles, and the degree of water retention of clothing articles made from different materials (cotton, synthetics etc), but freshly laundered articles of clothing nevertheless contain some amount of rinse water when placed in a clothes dryer, and for purposes of the present discussion are characterized as “damp.” The fabric treating composition transfers from the water-activated dryer sheet to the damp clothing, moving throughout the rinse water held in the clothing, and migrates from one article of clothing to another as the water-activated dryer sheet and clothing contact one another while being tumbled together within the rotary clothes dryer. It is believed that the water-activated dryer sheet need not make contact with the water contained in each individual article of clothing, but that it need only contact at least some of the articles to transfer the composition thereon. Once some articles of clothing receive the fabric treating composition, they transfer it to other articles by contact with the rinse water in such other articles.

No heat is required to combine the components which make up the fabric treating composition of this invention. Moreover, unlike conventional dryer sheets such as Bounce®, no heat is required for the transfer of such composition from the dryer sheet of this invention to the damp clothing in the clothes dryer. As such, the dryer sheet of this invention is characterized as “water-activated” in the sense that the active ingredient(s) in the fabric treating composition transfers to clothing in a clothes dryer as a result of contact with the rinse water in the articles of clothing rather than due to the application of heat. In fact, the water-activated dryer sheet of this invention is ineffective if the articles of clothing in the dryer do not contain water. It is believed that the transfer of the fabric treating composition to the articles of clothing within the dryer occurs during an initial stage of the drying cycle when the clothing has its greatest water content but has not yet been heated to a temperature necessary to remove water from the damp clothing. When the clothing and the interior of the dryer reaches higher temperature, later in the drying cycle, the water content of the clothing is reduced. That is when prior art dryer sheets begin to function, i.e. the fabric treating composition placed on such dryer sheets melts and is transferred by physical contact with the heated clothing in the dryer. Such a transfer process is inefficient and ineffective compared to the water-activated dryer sheet of the present invention because the fabric treating composition is applied only to those parts or areas of the clothing with which the dryer sheet has direct contact. In contrast, the fabric treating composition of this invention is uniformly transferred to substantially the entire surface area of the clothing within the clothes dryer via the rinse water retained in the freshly laundered clothing.

### Example I

One example of a fabric treatment composition suitable for use in the water-activated dryer sheet was prepared with the following:

| | % wt |
|---|---|
| Water | 66.0 |
| “Plantatex” PW AM | 25.0 |
| “Dehyquart” AU 46/G | 5.6 |
| Fragrance | 3.0 |
| “Phenonip” | 0.4 |

Charge a mixing vessel with water. Add “Plantatex” PW AM with moderate agitation. After the mixture is uniform, add “Dehyquart” AU 46/G, fragrance and “Phenonip.” The “Plantatex” PW AM component is one formulation of “Plantatex” discussed above and “Dehyquart” AU 46/G is an anti-static agent, both of which are commercially available from Cognis Deutchland GmbH & Co. The “Phenonip” component is a preservative commercially available from Clariant AG of Muttenz, Switzerland.

While the invention has been described with reference to a preferred embodiment, it should be understood by those skilled in the art that various changes may be made and equivalents substituted for elements thereof without departing from the scope of the invention. Therefore it is intended that the invention not be limited to the particular embodiment disclosed as the best mode contemplated for carrying out the invention, but that the invention will include all embodiments falling within the scope of the appended claims.

What is claimed is:

1. A method of treating fabric in a clothes dryer, comprising:
(a) providing a non-woven substrate;
(b) providing a substantially non-ionic liquid fabric treating composition having at least one active ingredient;
(c) applying the fabric treating composition, in liquid form, to the non-woven substrate;
(d) following step (c), drying the fabric treating composition on the substrate to form a water-activated dryer sheet;
(e) placing damp clothing containing water into the interior of the clothes dryer;
(f) placing the water-activated dryer sheet into the interior of the clothes dryer with the damp clothing, the damp clothing and the water-activated dryer sheet not being enclosed together within a bag or other container during the course of a drying cycle while the damp clothing is being dried; and
(g) transferring an effective amount of the at least one active ingredient of the fabric treating composition from the water-activated dryer sheet to the damp clothing during the course of a drying cycle as a result of contact of the fabric treating composition with the water contained within the damp clothing.

2. The method of claim 1 in which step (b) comprises providing a substantially non-ionic liquid fabric treating composition including an active ingredient comprising a wax dispersion with glyceryl esters, an emulsifier and water.

3. The method of claim 1 in which step (b) comprises providing a substantially non-ionic liquid fabric treating composition having at least one active ingredient chosen from the group consisting of anti-creasing agents, anti-soil agents, brightening agents, bodying agents, softening agents, dyes, fiber emollients, finishing agents, insect repellants, germicides, lubricants, mildew-proofing agents, moth-proofing agents, shrinkage controllers and sizing agents.

4. The method of claim 1 in which step (b) comprises providing a substantially non-ionic liquid fabric treating composition having auxiliaries and additives chosen from the group consisting of anti-static agents, preservatives and fragrances.

5. A method of treating fabric in a clothes dryer, comprising:
(a) providing a non-woven substrate;
(b) providing a substantially non-ionic liquid fabric treating composition having at least one active ingredient;
(c) applying the fabric treating composition, in liquid form, to the non-woven substrate;
(d) following step (c), drying the fabric treating composition on the substrate to form a water-activated dryer sheet;
(e) placing damp clothing containing water into the interior of the clothes dryer;
(f) placing the water-activated dryer sheet into the interior of the clothes dryer with the damp clothing, the damp clothing and the dryer sheet not being enclosed together within a bag or other container during the course of a drying cycle while the damp clothing is being dried; and
(g) transferring an effective amount of the at least one active ingredient of the fabric treating composition from the water-activated dryer sheet to the damp clothing during the course of a drying cycle, prior to heating the damp clothing to a temperature necessary to remove water from the damp clothing, as a result of contact of the fabric treating composition with water contained within the damp clothing.

6. A method of treating fabric in a clothes dryer, comprising:
(a) providing a non-woven substrate;
(b) providing a substantially non-ionic liquid fabric treating composition having at least one active ingredient;
(c) applying the fabric treating composition, in liquid form, to the non-woven substrate;
(d) following step (c), drying the fabric treating composition on the substrate to form a water-activated dryer sheet;
(e) placing damp clothing containing water into the interior of the clothes dryer;
(f) placing the water-activated dryer sheet into the interior of the clothes dryer with the damp clothing, the damp clothing and the water-activated dryer sheet not being enclosed together within a bag or other container during the course of a drying cycle while the damp clothing is being dried; and
(g) transferring an effective amount of the at least one active ingredient of the fabric treating composition from the water-activated dryer sheet to the damp clothing during an initial stage of a drying cycle, beginning when the damp clothing has its greatest water content and prior to heating the damp clothing to a temperature necessary to remove water from the damp clothing, as a result of contact of the fabric treating composition with the water contained within the damp.

7. A method of treating fabric in a clothes dryer, comprising:
(a) providing a non-woven substrate;
(b) providing a substantially non-ionic liquid fabric treating composition including at least one active ingredient comprising a wax-based dispersion containing wax crystals and an emulsifier;
(c) applying the fabric treating composition, in liquid form, to the non-woven substrate, the emulsifier being effective to assist in maintaining the wax crystals suspended in the wax-based dispersion so that they are substantially evenly distributed on the substrate;
(d) following step (c), drying the fabric treating composition on the substrate to form a water-activated dryer sheet;
(e) placing damp clothing containing water into the interior of the clothes dryer;
(f) placing the water-activated dryer sheet into the interior of the clothes dryer with the damp clothing, the damp clothing and the dryer sheet not being enclosed together within a bag or other container during the course of a drying cycle while the damp clothing is being dried; and
(g) transferring an effective amount of the at least one active ingredient of the fabric treating composition from the water-activated dryer sheet to the damp clothing during the course of a drying cycle as a result of contact of the fabric treating composition with the water contained within the damp clothing.

8. The method of claim 7 in which step (b) comprises providing a substantially non-ionic liquid fabric treating composition including an active ingredient comprising a wax dispersion with glyceryl esters, an emulsifier and water.

9. A method of fabricating a water-activated dryer sheet, comprising:
(a) providing a non-woven substrate;
(b) providing a substantially non-ionic liquid fabric treating composition including at least one active ingredient comprising a wax-based dispersion containing wax crystals;
(c) applying the liquid fabric treating composition to the non-woven substrate;
(d) following step (c), drying the liquid fabric treating composition on the non-woven substrate at a temperature which is less than the melt temperature of the wax crystals within the wax-based dispersion to form a water-activated dryer sheet.

10. The method of claim 9 in which step (b) comprises providing a substantially non-ionic liquid fabric treating composition including an active ingredient comprising a wax-based dispersion including wax crystals, glyceryl esters and water.

11. The method of claim 9 in which step (d) includes drying the liquid fabric treating composition on the non-woven substrate at a temperature of less than about 40° C.

12. A method of fabricating a water-activated dryer sheet, comprising:
(a) providing a non-woven substrate;
(b) providing a substantially non-ionic liquid fabric treating composition including at least one active ingredient comprising a wax-based dispersion containing wax crystals;
(c) applying the liquid fabric treating composition to the non-woven substrate;
(d) following step (c), transporting the non-woven substrate to a drying station at which the liquid fabric treating composition is dried on the non-woven substrate at a temperature which is less than the melt temperature of the wax crystals within the wax-based dispersion to form a water-activated dryer sheet.

13. The method of claim 12 in which step (d) comprises transporting the non-woven substrate to an accumulator.

14. The method of claim 9 in which step (b) comprises providing a substantially non-ionic liquid fabric treating composition including an active ingredient comprising a wax-based dispersion including wax crystals, glyceryl esters and water.

15. The method of claim 9 in which step (d) includes drying the liquid fabric treating composition on the non-woven substrate at temperatures of less than about 40° C.
